(19) United States
(12) Patent Application Publication
(10) Pub. No.: US 2018/0169976 A1
(43) Pub. Date: Jun. 21, 2018

(54) METHOD FOR SELECTIVE PLACEMENT OF REINFORCING FIBERS IN POLYMERIC COMPONENTS

(71) Applicant: United Technologies Corporation, Farmington, CT (US)

(72) Inventors: Evan Butcher, Manchester, CT (US); Wendell V. Twelves, JR., Glastonbury, CT (US); Gary A. Schirtzinger, Glastonbury, CT (US); Joe Ott, Enfield, CT (US); Lexia Kironn, Rocky Hill, CT (US)

(21) Appl. No.: 15/826,142

(22) Filed: Nov. 29, 2017

Related U.S. Application Data
(63) Continuation of application No. 15/033,283, filed on Apr. 29, 2016, now abandoned.
(60) Provisional application No. 61/898,201, filed on Oct. 31, 2013.

(51) Int. Cl. B29C 70/54; F01D 25/00; B29C 53/82; B29C 70/16; B29C 70/22; B29C 70/34; B29C 70/86; B29C 53/56; B29K 79/00; B29K 105/00; B29K 105/10; B29L 1/00; B29L 31/00; B29K 71/00

(52) U.S. Cl. CPC B29C 70/543; B29K 2995/0017; B29C 53/822; B29C 53/828; B29C 70/16; B29C 70/22; B29C 70/347; B29C 70/541; B29C 70/86; B29C 70/865; B29C 53/564; B29K 2079/085; B29K 2105/0058; B29K 2105/101; B29K 2105/251; F05D 2300/436; B29L 2001/00; B29L 2031/748; B29L 2031/7504; B29K 2071/00; F01D 25/005

(57) ABSTRACT

A method of forming a reinforced polymeric component includes securing a plurality of pins within a mold and wrapping reinforcing fibers around the pins to form a web of reinforcing fibers. The web of reinforcing fibers has a plurality of layers. The method of forming a reinforced polymeric component further includes adding a polymer to the mold and processing the polymer to form a molded polymeric component that contains the pins and the web of reinforcing fibers.
A reinforced polymeric component includes a web of reinforcing fibers wrapped around a plurality of pins. The web of reinforcing fibers includes a plurality of layers. The reinforced polymeric component further includes a molded and processed polymer containing the web of reinforcing fibers and pins.

### CROSS-REFERENCE TO RELATED APPLICATION(S)

This application is a continuation of U.S. Application Ser. No. 15/033,283 filed Apr. 29, 2016 for “A METHOD FOR SELECTIVE PLACEMENT OF REINFORCING FIBERS IN POLYMERIC COMPONENTS” by E. Butcher, W. Twelves, Jr., G. Schirtzinger, J. Ott and L. Kironn, which in turn claims the benefit PCT International Application No. PCT/US2014/063312 filed Oct. 31, 2014 for “A METHOD FOR SELECTIVE PLACEMENT OF REINFORCING FIBERS IN POLYMERIC COMPONENTS” by E. Butcher, W. Twelves, Jr., G. Schirtzinger, J. Ott and L. Kironn, which in turn claims the benefit of U.S. Provisional Application No. 61/898,201 filed Oct. 31, 2013 for “A METHOD FOR SELECTIVE PLACEMENT OF REINFORCING FIBERS IN POLYMERIC COMPONENTS” by E. Butcher, W. Twelves, Jr., G. Schirtzinger, J. Ott and L. Kironn.

### BACKGROUND

The present invention relates generally to gas turbine engine components and, more particularly, to gas turbine engine components made from high-temperature polymers.

Using a high-temperature polymer such as polyether ether ketone (PEEK) or polytheramide, such as Ultem, to make aircraft engine components has several advantages. In particular, high-temperature polymers make low-density components with the capacity to withstand high temperatures. Because mechanical properties fall as temperature rises, high-temperature polymer components are typically reinforced with load-bearing inserts. However, using load-bearing inserts requires curing multiple layers of discontinuous material.

### SUMMARY

A method of forming a reinforced polymeric component includes securing a plurality of pins within a mold and wrapping reinforcing fibers around the pins to form a web of reinforcing fibers. The web of reinforcing fibers has a plurality of layers. The method of forming a reinforced polymeric component further includes adding a polymer to the mold and processing the polymer to form a molded polymeric component that contains the pins and the web of reinforcing fibers.

A reinforced polymeric component includes a web of reinforcing fibers wrapped around a plurality of pins. The web of reinforcing fibers includes a plurality of layers. The reinforced polymeric component further includes a molded and processed polymer containing the web of reinforcing fibers and pins.

### BRIEF DESCRIPTION OF THE DRAWINGS

FIG. 1 is a perspective view of an embodiment of reinforcing fibers in a mold.

FIG. 2 is a perspective view of an embodiment of a mold.

FIG. 3 is a perspective view of a fiber alignment pin.

FIG. 4 is a perspective view of a molded polymeric component.

### DETAILED DESCRIPTION

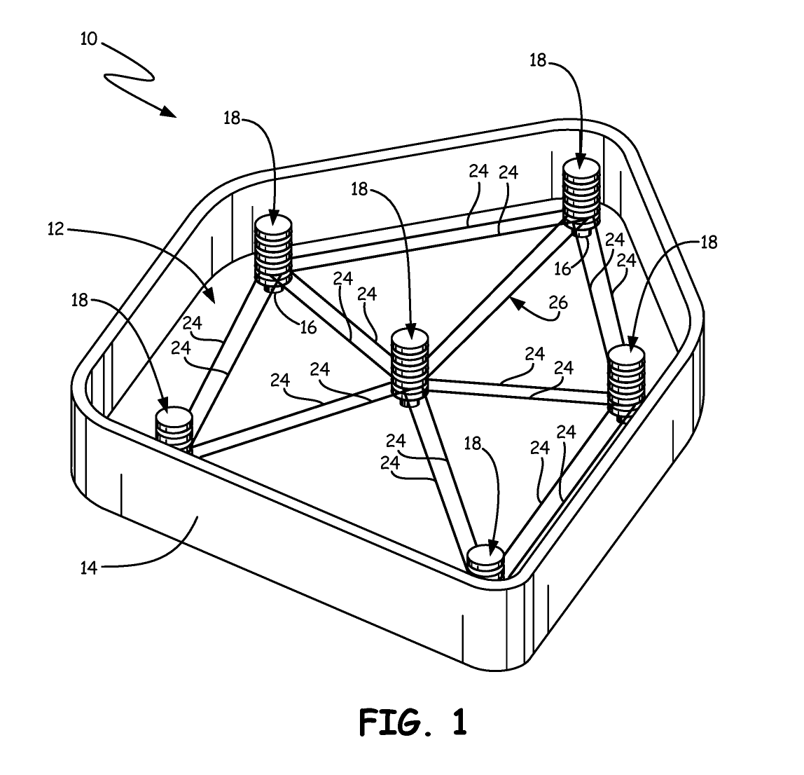

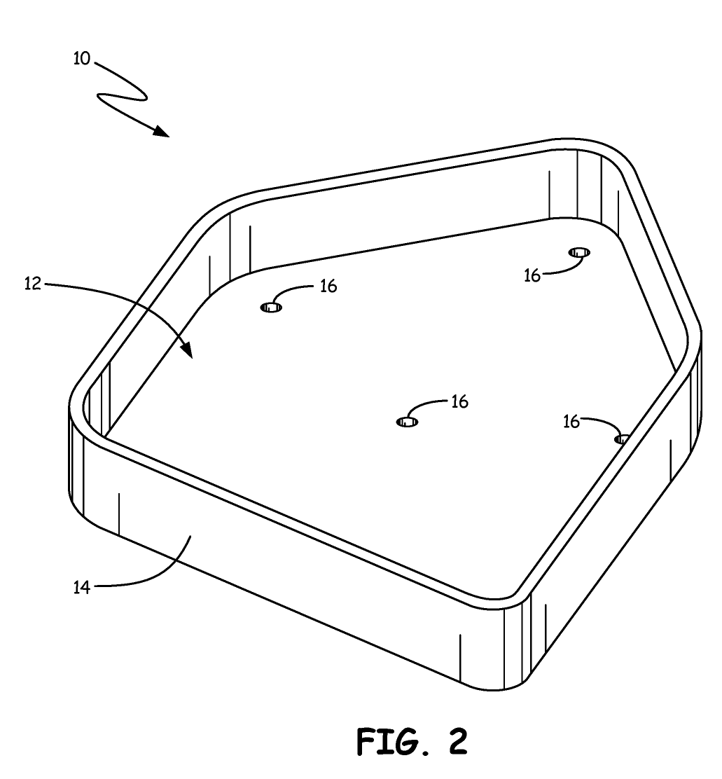

FIGS. 1 and 2 are perspective views of an embodiment of mold 10. Mold 10 includes base 12 and side wall 14. Base 12 includes holes 16, configured to secure alignment pins 18, as shown in FIG. 1. Alignment pins 18 include ribs 20 and grooves 22, which are configured to align reinforcing fibers 24. In FIG. 2, alignment pins 18 are not shown so that holes 16 can be seen.

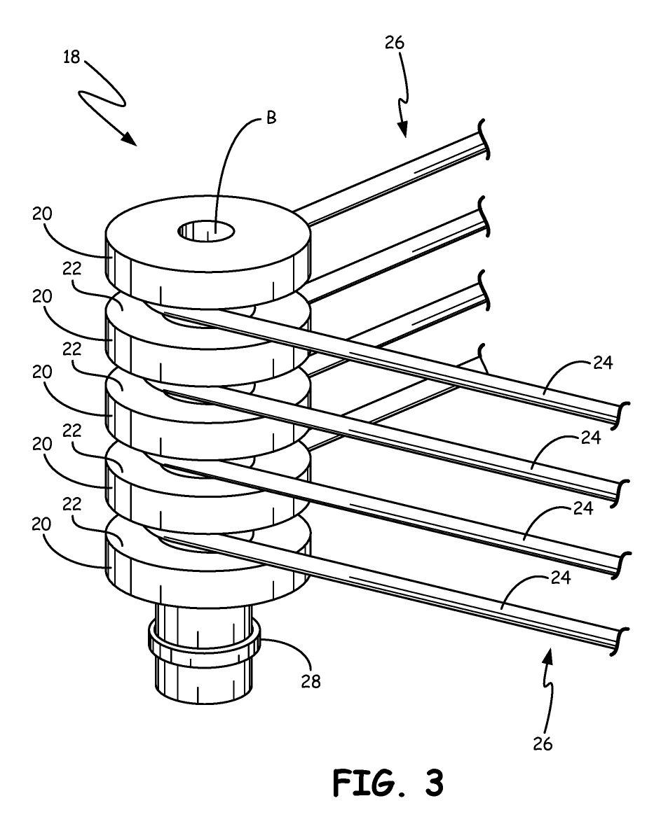

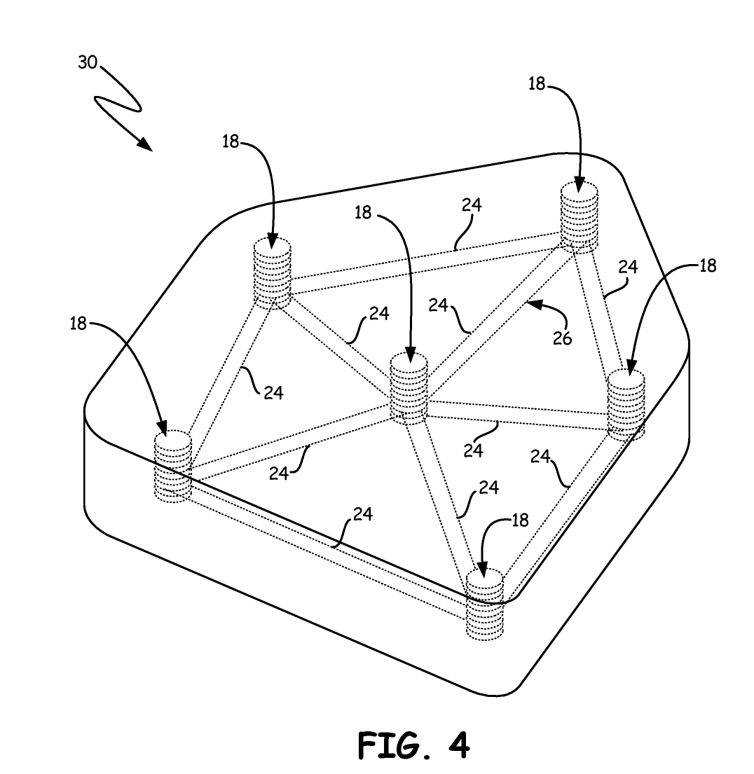

Mold 10 forms a container for holding a polymer, such as PEEK or Ultem, in liquid or powder form while the polymer is being processed. Mold 10 may be any shape that may be used to form a reinforced polymeric component. Mold 10 may be any material suitable for processing a polymer. Base 12 is connected to side wall 14. Together, base 12 and side walls 14 form the exterior of mold 10. Base 12 further includes holes 16, which are arranged in a pattern representing desired points of reinforcement, discussed further in FIG. 2. Holes 16 are configured to secure alignment pins 18 in place by providing a close-fitting coupling. Alignment pins 18 are secured in the horizontal plane of mold 10 but may be lifted out of mold 10 when a reinforced polymeric component is lifted out of mold 10. Gaskets may be used to seal between holes 16 and alignment pins 18. Alignment pins 18 are positioned within holes 16 in the same pattern representing desired points of reinforcement, discussed further in conjunction with FIG. 4. Alignment pins 18 contain a plurality of ribs 20 and a plurality of grooves 22, which hold reinforcing fibers 24 in place, discussed further in FIG. 3. Reinforcing fibers 24 are drawn taut and secured around alignment pins 18 to form web 26 within mold 10. Reinforcing fibers 24 may be a single strand or multiple strands wound around alignment pins 18. Web 26 may have a plurality of layers depending on the degree of reinforcement desired, discussed further in conjunction with FIG. 3.

FIG. 3 is a perspective view of an embodiment of alignment pin 18. Alignment pin 18 includes a plurality of ribs 20 and a plurality of grooves 22, which are configured to hold reinforcing fibers 24. Gasket 28 is configured to seal alignment pin 18 into a hole in the base of the mold (not shown).

The number of ribs 20 and grooves 22 may vary depending on the number of reinforcing fibers 24 desired. The vertical position of grooves 22 may vary depending on the separation of reinforcing fibers 24 desired. The width of grooves 22 may vary to accommodate multiple strands of reinforcing fibers 24. Reinforcing fibers 24 pass between ribs 20. Alignment pin 18 forms a stable point around which reinforcing fibers 24 are pulled taut. Alignment pin 18 may provide attachment hard points for a molded component. For example, alignment pin 18 may include a bore B or thread.

To form a reinforced polymeric component, a plurality of pins 18 are secured within a mold 10. Reinforcing fibers 24 are wrapped around pins 18 to form web 26 of reinforcing fibers 24. Web 26 may include a plurality of layers. A polymer is added to mold 10 and processed to form a reinforced polymeric component that contains pins 18 and web 26. Pins 18 within mold 10 provide a nexus for reinforcing fibers 24 and are located at desired attachment points and load path tailored points on the molded polymeric component. Pins 18 typically include pins 18 secured near a periphery of mold 10 to provide attachment points. Mold 10, to which the polymer is added, comprises a container having base 12 comprising a plurality of holes 16 for securing pins 18. Holes 16 are close-fitting to form a seal around pins 18, and gaskets 28 may be used to aid in sealing around pins 18. The polymer added to mold 10 is a polymer capable of service in the thermal environment the component will see. Most preferably, the polymer is a high-temperature polymer. The polymer may be added to mold 10 in liquid or powder form. Following processing, the molded polymeric component is disengaged from mold 10.

FIG. 4 is a perspective view of a reinforced polymeric component 30 produced by the above method. Reinforced polymeric component 30 includes alignment pins 18 and web 26. Web 26 includes reinforcing fibers 24.

Reinforced polymeric component 30 may be any shape desired for a particular environment within a gas turbine engine. Reinforced polymeric component 30 may comprise any molded and processed polymer capable of service in the particular environment in which reinforced polymeric component 30 is placed. Alignment pins 18 are disengaged from a mold (not shown, discussed above), and contained within polymeric component 30. Alignment pins 18 may be in any pattern, most preferably the pattern representing desired points of reinforcement along the load-bearing path of reinforced polymeric component 30.

### Discussion of Possible Embodiments

The following are non-exclusive descriptions of possible embodiments of the present invention.

A method of forming a reinforced polymeric component, according to an exemplary embodiment of this disclosure, among other possible things, includes securing a plurality of pins within a mold and wrapping reinforcing fibers around the pins to form a web of reinforcing fibers. The web has a plurality of layers. The method of forming a reinforced polymeric component further includes adding a polymer to the mold and processing the polymer to form a molded polymeric component containing the web of reinforcing fibers and pins.

The method of forming a reinforced polymeric component of the preceding paragraph can optionally include, additionally and/or alternatively, any one or more of the following features, configurations and/or additional components:

A further embodiment of the foregoing method of forming a reinforced polymeric component, wherein each of the pins provides a nexus for the reinforcing fibers.

A further embodiment of any of the foregoing methods of forming a reinforced polymeric component, wherein the pins are located at desired attachment points and load path tailored points on a molded polymeric component.

A further embodiment of any of the foregoing methods of forming a reinforced polymeric component, wherein the plurality of pins typically include pins secured near a periphery of the mold to provide attachment hard points.

A further embodiment of any of the foregoing methods of forming a reinforced polymeric component, wherein the mold comprises a container having a base comprising a plurality of holes configured to secure the pins.

A further embodiment of any of the foregoing methods of forming a reinforced polymeric component, wherein close-fitting holes or a plurality of gaskets are configured to seal around the pins at the holes configured to secure the pins.

A further embodiment of any of the foregoing methods of forming a reinforced polymeric component, wherein the polymer is capable of service in the thermal environment the component will see. Preferably, the polymer is a high-temperature polymer.

A further embodiment of any of the foregoing methods of forming a reinforced polymeric component, wherein the polymer is added in liquid or powder form.

A further embodiment of any of the foregoing methods of forming a reinforced polymeric component, wherein the molded polymeric component is disengaged from the mold.

A reinforced polymeric component, according to an exemplary embodiment of this disclosure, among other possible things, includes a web of reinforcing fibers wrapped around a plurality of pins. The web has a plurality of layers. The reinforced polymeric component further includes a molded and processed polymer containing the web of reinforcing fibers and pins.

The reinforced polymeric component of the preceding paragraph can optionally include, additionally and/or alternatively, any one or more of the following features, configurations and/or additional components:

A further embodiment of the foregoing reinforced polymeric component, wherein the pins comprise a plurality of ribs.

A further embodiment of any of the foregoing reinforced polymeric components, wherein the pins are configured to provide a bolt or screw attachment feature and to act as a hard point in the reinforced polymeric component.

A further embodiment of any of the foregoing reinforced polymeric components, wherein the pins are located at desired attachment points and load path tailored points on the molded polymeric component.

A further embodiment of any of the foregoing reinforced polymeric components, wherein the polymer is capable of service in the thermal environment the component will see. Preferably, the polymer is a high-temperature polymer.

A further embodiment of any of the foregoing reinforced polymeric components, wherein the polymer is molded in liquid or powder form.

While the invention has been described with reference to an exemplary embodiment(s), the invention will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed but that the invention will include all embodiments falling within the scope of the appended claims.

1. A method of forming a reinforced polymeric component, the method comprising:
securing a plurality of pins within a mold;
wrapping reinforcing fibers around the pins to form a web of reinforcing fibers, wherein the web has a plurality of layers;
filling the mold with a polymer;
processing the polymer to form a molded polymeric component in the shape of the mold, the molded polymeric component containing the web of reinforcing fibers and pins embedded therein; and
disengaging the molded polymeric component from the mold.

2. The method of forming a reinforced polymeric component of claim 1, wherein each of the pins provides a nexus for the reinforcing fibers.

3. The method of forming a reinforced polymeric component of claim 2, wherein the pins are located at desired attachment points and load path tailored points on a molded polymeric component.

4. The method of forming a reinforced polymeric component of claim 3, wherein the plurality of pins typically include pins secured near a periphery of the mold to provide attachment hard points.

5. The method of forming a reinforced polymeric component of claim 1, wherein the mold comprises a container having a base comprising a plurality of holes configured to secure the pins.

6. The method of forming a reinforced polymeric component of claim 5, wherein close-fitting holes or a plurality of gaskets are configured to seal around the pins at the holes configured to secure the pins.

7. The method of forming a reinforced polymeric component of claim 1, wherein the polymer is capable of service in the thermal environment the component will see. Preferably, the polymer is a high-temperature polymer.

8. The method of forming a reinforced polymeric component of claim 1, wherein the polymer is added in liquid or powder form.

9. The method of forming a reinforced polymeric component of claim 1, wherein filling the mold with the polymer comprises inserting the polymer throughout the mold.

10. A reinforced polymeric component comprising:
a web of reinforcing fibers wrapped around a plurality of pins, wherein the web has a plurality of layers; and
a molded and processed polymer containing the web of reinforcing fibers and pins.

11. The reinforced polymeric component of claim 10, wherein the pins comprise a plurality of ribs.

12. The reinforced polymeric component of claim 11, wherein the pins are configured to provide a bolt or screw attachment feature and to act as a hard point in the reinforced polymeric component.

13. The reinforced polymeric component of claim 12, wherein the pins are located at desired attachment points and load path tailored points on the molded polymeric component.

14. The reinforced polymeric component of claim 10, wherein the polymer is capable of service in the thermal environment the component will see. Preferably, the polymer is a high-temperature polymer.

15. The reinforced polymeric component of claim 10, wherein the polymer is molded in liquid or powder form.
